(19) United States
(12) Patent Application Publication
(10) Pub. No.: US 2026/0028287 A1
(43) Pub. Date: Jan. 29, 2026

(54) Electro-cementation of Onshore Calcareous Sand Using Colloidal Silica (CS) Nanoparticles and Alumina Powder and the Incorporation of Electrokinetic Geosynthetics (EKGs)

(71) Applicant: The American University in Cairo, New York, NY (US)

(72) Inventors: Nermeen Fouad Ashour, Dokky, Giza (EG); Safwan Khedr, New Cairo, Cairo Governorate (EG)

(21) Appl. No.: 18/998,716

(22) PCT Filed: Jul. 12, 2023
(86) PCT No.: PCT/US2023/027547

§ 371 Date: Jan. 27, 2025

Related U.S. Application Data
(60) Provisional application No. 63/393,207, filed on Jul. 28, 2022.

(51) Int. Cl. C04B 40/00; C04B 14/06; C04B 14/30; C04B 28/26; C04B 111/00

(52) U.S. Cl. CPC C04B 40/0007; C04B 14/06; C04B 14/303; C04B 28/26; C04B 2111/00732; C04B 2201/50

(57) ABSTRACT

A stabilization or electro-cementation method of calcareous sand is provided. Calcareous sand, SiO₂ nanoparticles, AI₂O₃ powder and NaCl solution are first mixed. The mixture is treated by passing a DC current through the mixture in which the applied voltage is sufficient as a decomposition voltage of the mixture to cause electrolysis so that pozzolanic reactions can take place within the mixture. Pozzolanic reactions continue to take place beyond the electrokinetic (EK) treatment time. In one embodiment, the post EK treatment time required to achieve hardening caused by pozzolanic reactions can last for at least 60 days. Once the treatment is considered satisfactory, the treated mixture can be tested or loaded. The compressive and shear strengths of the treated sand are significantly improved. The nature of the treated soil is changed from a granular material into a rock. The method has a low carbon footprint compared to other stabilization methods.

### FIELD OF THE INVENTION

This invention relates to methods for stabilization of calcareous sand.

### BACKGROUND OF THE INVENTION

Calcareous sand is a problematic type of soil due to its high void ratios, irregular particle shape, high compressibility, and crushability. It mainly consists of calcareous bioclastic remains. These fragmented bones by nature have micro intra and inter pores leading to the characteristic porosity of the calcareous sand. The intra pores result in high crushability, and consequently low load carrying capacity. Calcareous sand is considerably more compressible than silica sand. It can sometimes be 30 times more compressible than quarzitic sands under the same loading conditions and stress levels.

Calcareous sand covers approximately 50% of the seafloor on Earth with predominance in tropical and subtropical regions. The increase in population and the subsequent urbanization have led to the inevitable need for the construction on problematic soils such as calcareous sand. Geotechnical engineers are often challenged to come up with unconventional technologies and innovative materials in the field of ground improvement to overcome geotechnical challenges and at the same time conform to environmental sustainability standards which have become one of the world's foremost goals. Traditional stabilization materials used in ground improvement, including cement and chemical stabilizers such as synthetic polymers have negative environmental impacts, in addition to their limitations in nondisruptive field treatments. The manufacturing industry of cement alone emits 8-10% of the global CO₂ emissions. This is because the production of 1 ton of cement results in 1 ton of CO₂ being released into the atmosphere. Cement also has a high pH value, which can be a problem when a controlled and stable environment is needed.

The present invention advances the art with new stabilization techniques to overcome at least some of the current problems.

### SUMMARY OF THE INVENTION

Introducing nanomaterials as new soil stabilization materials is an important step towards green and sustainable construction. Among the nanomaterials used in soil stabilization is colloidal silica (CS). While calcium carbonate can treat siliceous sands, much less is known about the effect of silica on the behavior of calcareous sands. Therefore, the present invention adopts a novel ideology for the stabilization of calcareous sand; an obscure soil, using CS; a new-level nanomaterial.

In one embodiment the invention is characterized as a method of stabilization or electro-cementation of calcareous sand. Calcareous sand, SiO₂ nanoparticles, Al₂O₃ powder and NaCl solution are first mixed. Then the mixture is treated by passing a DC current through the mixture at a DC current intensity sufficient to ensure pozzolanic reactions to take place within the mixture. In one embodiment, the treatment can last at least 60 days. Once the treatment is considered satisfactory, the treated mixture can be tested or loaded. In one example, but not limiting to the scope of the invention, the applied voltage is in the range of 12 V to 36 V which was used for the initial experiments for the purposes of the invention. In one embodiment, the passing of the DC current can be accomplished by using double stainless-steel/iron plate electrodes or one stainless-steel/iron plate electrode as the anode along with an electrokinetic geosynthetic (EKG) comprising an iron mesh and a geomembrane as the cathode.

The SiO₂ has a percent weight ratio within the mixture relative to the calcareous sand in a range of 10% to 20%. The Al₂O₃ has a percent weight ratio within the mixture relative to the calcareous sand in a range of 1% to 10%. The predetermined concentration of NaCl solution is equal to the concentration of salt in seawater which is about 35 parts per thousand (3.5%) or about 0.6M.

Embodiments of the invention have a low carbon footprint compared to other conventional chemical stabilization methods, such as cement-treated sand using ordinary Portland cement whose industry alone emits 8-10% of the total global CO₂ emissions.

The formation of slaked lime [Ca(OH)₂] is necessary for the formation of cementitious materials. Pozzolanic reactions between Ca(OH)₂ and reactive silica and alumina in the presence of water at ambient temperature lead to the formation of C—S—H and C-A-H gels, respectively. To obtain Ca(OH)₂, a reaction between Ca²⁺ metal cation and OH⁻ group is required to take place. Electrolysis of CaCO₃ allows that by freeing Ca²⁺ ions. The resulting metal cation Ca²⁺ and carbonate anion CO₃²⁻ migrate to the electrode of opposite charge, forming Ca(OH)₂ at the cathode and carbonic acid (H₂CO₃) at the anode, respectively. The electrolysis of calcium carbonate is the greener alternative to its calcination as in cement manufacturing process. Calcination is the thermal decomposition of CaCO₃ which results in the conversion of carbonates to oxides, forming CaO, the precursor compound to Ca(OH)₂. Calcination takes place at extremely high temperatures [1200° C. to 1500° C.], making the process a major contributor to CO₂ emissions. Whereas electrolysis is the ionic dissociation of CaCO₃ by separating the cation (Ca²⁺) from the anion (CO₃)²⁻ without the need for high temperatures.

Furthermore, the CO₂ that results from the electrolysis reaction dissolves in water between pH values 8 and 10, forming dissolved carbonic acid (a weak acid). This way of disposal of CO₂ makes the treatment have a low carbon footprint which conforms to environmental sustainability standards.

In addition, introducing colloidal silica nanoparticles as a soil stabilization material is an important step towards green and sustainable construction as nano science is now regarded as the newest leading science and technology field of the current century.

### BRIEF DESCRIPTION OF THE DRAWINGS

FIG. 1 shows according to an exemplary embodiment of the invention energy dispersive x-ray (EDX) of untreated calcareous sand.

FIG. 2 shows according to an exemplary embodiment of the invention grain size distribution curve for untreated calcareous sand.

FIG. 3 shows according to an exemplary embodiment of the invention TEM images for CS nanoparticles.

FIGS. 4A-B show according to an exemplary embodiment of the invention EK cell (FIG. 4A) at the start of the EK treatment and (FIG. 4B) after the treatment.

FIG. 5 shows according to exemplary embodiments of the invention a block diagram for electric components in the test setup.

FIG. 6 shows according to an exemplary embodiment of the invention variation in current intensity with time at constant voltage=24 V.

FIG. 7 shows according to an exemplary embodiment of the invention the incorporation of electrokinetic geosynthetic (EKG) as the cathode in the EK cell.

FIG. 8 shows according to an exemplary embodiment of the invention image showing the treated soil changed from a granular material into a rock.

FIGS. 9A-B show according to an exemplary embodiment of the invention SEM images of calcareous sand (FIG. 9A) before and (FIG. 9B) after the treatment.

FIG. 10 shows according to an exemplary embodiment of the invention an SEM image of iron-rich cements formed within treated sand samples with EK only without chemical stabilizers.

FIGS. 11A-B show according to an exemplary embodiment of the invention SEM images displaying (FIG. 11A) hexagonal plates of Portlandite [Ca(OH)₂] and (FIG. 11B) C—S—Hs formed within the treated sand samples.

FIG. 12 shows according to an exemplary embodiment of the invention self-oriented rosettes of C—S—Hs grown in treated sand samples.

FIGS. 13A-D show according to an exemplary embodiment of the invention various microstructures of C—S—Hs grown in treated sand samples including (FIG. 13A) nodules at Mag 4.5K, (FIG. 13B) nodules at Mag 15K, (FIG. 13C) needle form and (FIG. 13D) rods.

FIGS. 14A-B show according to an exemplary embodiment of the invention SEM images showing the growth of C—S—H (FIG. 14A) on surface of individual sand grains and (FIG. 14B) between sand grains.

FIG. 15 shows according to an exemplary embodiment of the invention an SEM image showing the growth of tobermorite in treated samples.

FIGS. 16A-B show according to an exemplary embodiment of the invention alpha-dicalcium silicate hydrate (hillebrandite), α-C₂SH (Ca₂[HSiO₄](OH)), detected by (FIG. 16A) SEM imaging and (FIG. 16B) XRD analysis.

FIGS. 17A-B show according to an exemplary embodiment of the invention SEM images of octahedral hydrogarnet and honeycomb structures of C—S—Hs detected in sample containing 1% alumina at Mag (FIG. 17A) 1.87 K and (FIG. 17B) 5.1 K.

FIG. 18 shows according to an exemplary embodiment of the invention an SEM image of calcium aluminate, possibly pleochroite, formed on the surface of a sand grain.

FIGS. 19A-B show according to an exemplary embodiment of the invention SEM images of ettringites (AFT) and C—S—Hs formed on sand grains of treated sample at Mag (FIG. 19A) 262 and (FIG. 19B) 813.

FIG. 20 shows according to an exemplary embodiment of the invention an SEM image of floral formations of C-A-Hs formed within treated samples.

FIG. 21 shows according to an exemplary embodiment of the invention an SEM image of a rosette of layered C-A-H grown between C—S—Hs in the treated sand samples.

FIG. 22 shows according to an exemplary embodiment of the invention nano features confirmed by FE-SEM imaging.

FIGS. 23A-B show according to an exemplary embodiment of the invention SEM images of nano-sized aluminate hydrates formed on the surface of individual calcareous sand particles at (FIG. 23A) Mag 2.6K x and (FIG. 23B) Mag 6K x.

FIG. 24 shows according to an exemplary embodiment of the invention energy dispersive x-ray (EDX) analysis for treated sand samples.

### DETAILED DESCRIPTION

The present invention is a ground improvement technique that concerns the electro-cementation of calcareous sand obtained from a site 300 Km northwest of Cairo and 30 km east of Al Dabaa, which is the location of a proposed nuclear power plant in Egypt. X-ray fluorescence testing showed that the samples contained 95.34% calcium carbonate. Colloidal silica (CS) nanoparticles were synthesized by the acidification of commercially available sodium silicate solution. CS nanoparticles (SiO₂) and alumina powder (Al₂O₃) were added as predetermined percent weights of the treated sand samples and a DC current was passed through the sand-silica-alumina mix inside an electrokinetic (EK) cell.

The method results in the electro-cementation of the calcareous sand through the formation of calcium silicate hydrates (C—S—Hs) and calcium aluminate hydrates (C-A-Hs) in the treated sand samples after electrolysis occurs and due to Pozzolanic reactions which continue beyond treatment time. In addition, iron-rich cements are also formed due to the degradation of stainless-steel/iron electrodes which are used as sacrificed anodes.

Electrokinetic geosynthetics (EKGs) were incorporated in the treatment in the form of a combined material of geomembrane and iron mesh. These inclusions have a passive role in field application, by acting as impervious membranes to retain the aqueous electrolyte, and an active role by serving as cathodes. The treatment brings about improved engineering properties.

Results showed that the compressive and shear strengths of the treated sand were significantly improved. The electro-cementation achieved by the treatment was further assessed by spectroscopic analyses which confirmed the formation of cementing agents in the structure of the soil. Applications of the embodiments of this invention include caissons, stabilization of subgrades of roads in highway construction projects, dune fixation, erosion control, contamination barriers for nuclear waste near nuclear plants/facilities, and liquefaction mitigation due to electrolysis of pore water and plugging the pores with cementitious materials.

### Mechanism of Treatment

Electrokinetic stabilization is a ground improvement method that has been employed for dewatering, consolidation, stabilization, and contaminant removal of crystalline minerals in soils. It is a physicochemical transport of charge in which ions migrate within the soil mass towards the electrode of the opposite charge, resulting in changes in soil pH. This transport occurs due to electrolysis reactions. These reactions alter the soil's chemical composition and cause mineral formation. Electrokinetic stabilization includes four main transport mechanisms within the soil mass: electroosmosis, electrolysis, electrophoresis, and electromigration. Electroosmosis is the movement of pore water through the soil from the anode to the cathode. Electrophoresis is the movement of charged particles, including colloids and organic particles, causing sedimentation. Electromigration is the movement of ions in a soil due to an applied electric field. The ions move towards the electrode of opposite charge, anions towards the anode and cations towards the cathode.

The proposed treatment induces electrochemical reactions that generate electro-cementation in calcareous sand, which is brought about by electrolysis, electromigration, ion precipitation and pozzolanic activity. Pozzolanic materials introduced to the calcareous sand are CS nanoparticles and alumina powder.

The electric current obtained from the power supply is used to force the chemicals in the electrolytic cell to undergo chemical reactions after their electrolysis takes place. Hardening of the treated soil is achieved at both the anode and the cathode because of ion migration and exchange leading to the formation of new minerals (mineralization) and their precipitation inside the soil mass.

Passing an electric current causes metal degradation of the anode. As a result, metal atoms are lost from the surface of the anode and deposited into the sand in the form of metal cations, as shown in Equation 1. Electrolysis of H₂O takes place in the Ek cell, as shown in Equations 2 and 3. Positively charged hydrogen ions and negatively charged hydroxyl ions migrate to the electrode of opposite charge. Ferrous ions migrate towards the cathode and react with hydroxyl groups to give ferrous hydroxide [Fe(OH)₂], as shown in Equation 4. Moreover, further oxidation and the precipitation of ferric ions (Fe³⁺) lead to the formation of ferrihydrite (Fe(OH)₃·nH₂O), as shown in Equation 5, resulting in the precipitation of more iron-rich cements within the treated sand. Precipitated ferric oxyhydroxide minerals include maghemite γ-Fe₂O₃, hematite α-Fe₂O₃, lepidocrocite γ-FeOOH and goethite α-FeOOH. These minerals are all originally ferrihydrite (rust) which is Fe(OH)₃·nH₂O, a metastable amorphous compound formed in the cathodic region.

On the other hand, electrolysis of CaCO₃ takes place in the EK cell and Ca²⁺ ions are freed, as shown in Equation 6. The resulting metal cation Ca²⁺ and carbonate anion CO₃²⁻ migrate to the electrode of opposite charge, forming Ca(OH)₂ at the cathode and carbonic acid (H₂CO₃) at the anode, respectively. The electrolysis of calcium carbonate is equivalent to its calcination during cement manufacture. Calcination is the thermal decomposition of CaCO₃ which results in the conversion of carbonates to oxides, forming CaO. This takes place at extremely high temperatures, making the process a major contributor to CO₂ emissions. Whereas electrolysis is the ionic dissociation of CaCO₃ separating the cation (Ca²⁺) part of the compound from the anion part (CO₃)²⁻. Carbon dioxide that results from the electrolysis reaction dissolves in water between pH values 8 and 10, forming dissolved carbonic acid, as shown in Equations 7 and 8. This disposal of CO₂ makes the proposed treatment have a low carbon footprint. Ferrous ions (Fe²⁺) which are precipitated in the sand mix react with the carbonate anions (CO₃)²⁻ to form the mineral siderite (FeCO₃), as shown in Equation 9.

Simultaneously, the electrolysis of SiO₂ and Al₂O₃ occurs, as shown in Equations 10 and 11. Ion migrations of free and ready-to-react Ca²⁺, Si⁺, Al²⁺, CO₃²⁻ and OH⁻ towards the electrode of opposite charge take place. Reaction between Ca²⁺ metal cation and OH⁻ group takes place giving slaked lime Ca(OH)₂, as shown in Equation 12. The formation of slaked lime is necessary for the formation of cementitious materials. Pozzolanic reactions between Ca(OH)₂ and reactive silica and alumina in the presence of water at ambient temperature lead to the formation of C—S—H and C-A-H gels, respectively, as shown in Equations 13 and 14. These gels fill the pores of the treated sand and bond the particles together.

The EK treatment lasted 7 days. After the completion of the EK treatment, the treated calcareous sand is left inside the EK cell for 60 days before sample extraction. Although the current ceased, the pozzolanic activity continues beyond the treatment time. Crystallization and recrystallisation of the newly formed cementitious materials bring about more hardening to the treated sand.

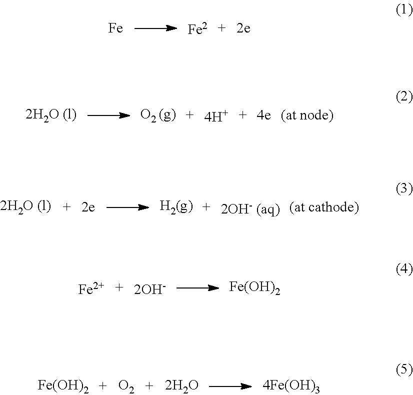

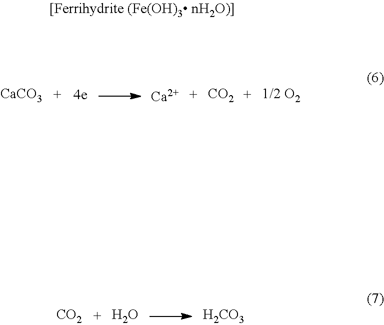

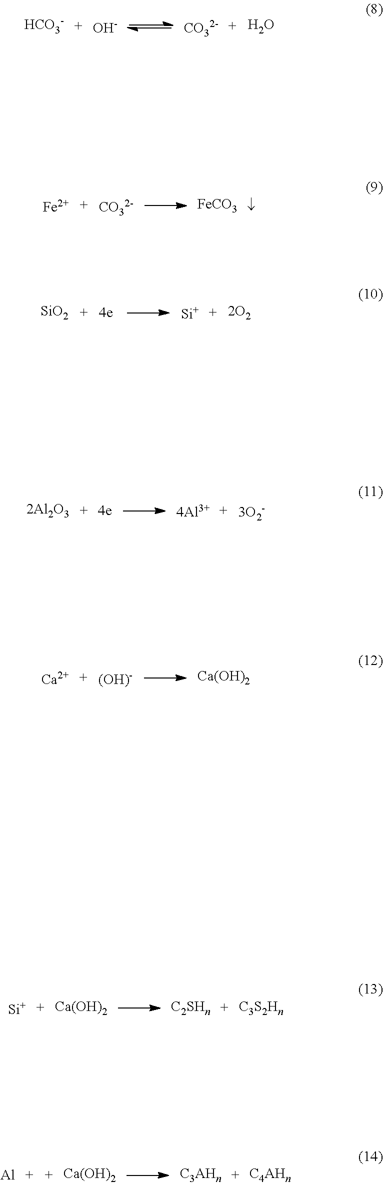

### Materials Used

### Calcareous Sand

Calcareous sand used in this study was obtained from a site 300 Km northwest of Cairo and 30 km east of Al Dabaa. The sand particles show variation in shape from rounded to subrounded and subangular. The colour of the particles vary from light tan to white. Individual particles are characterized by having rough surfaces.

### Chemical Composition of Calcareous Sand

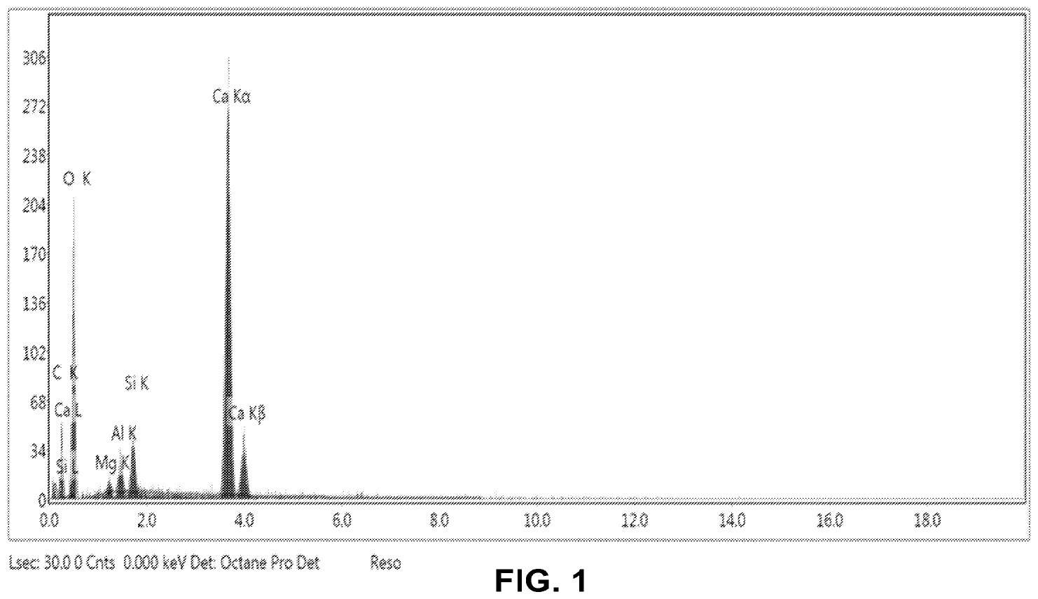

Chemical characterization and elemental analysis of calcareous sand were carried out using x-ray fluorescence (XRF) and energy dispersive x-ray (EDX) tests, respectively. The analyses showed that the calcareous sand samples have 95.34% calcium carbonate content and traces of quartz and other minerals and ions. The chemical composition using XRF analysis of the untreated calcareous sand is indicated in Table 1. FIG. 1 shows the EDX analysis for untreated calcareous sand.

### Geotechnical Characterization of Calcareous Sand

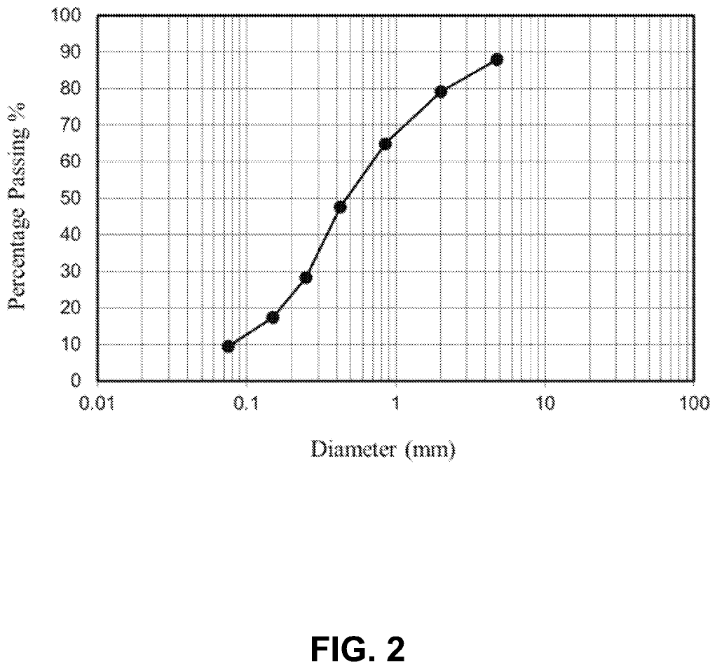

The grain size distribution was determined in general accordance with the Standard Test Method for Particle-Size Analysis of Soils, ASTM D422-63(1998). The coefficient of uniformity, Cu, and the coefficient of curvature, C_{c}, determined from the results of the particle size analysis were 1.4, and 1.03, respectively. The Maximum and minimum void ratios for the calcareous sand are 1.045 and 0.752, respectively. The sand is classified as calcite-sand according to (Hallsworth C R, Knox Robert. 1999). FIG. 2 shows the gradation curve of the calcareous sand. The sand is poorly graded (SP) according to the Unified Soil Classification System (USCS) with a specific gravity of 2.74. Modified Proctor compaction test was conducted on the calcareous sand according to the Standard Test Methods for Laboratory Compaction Characteristics of Soil Using Modified Effort, ASTM D1557. The compaction test results show that the maxi-mum dry unit weight for the calcareous sand is 2.07 gm/cm³ and the optimum moisture content is 8%.

TABLE 1
XRF analysis of untreated calcareous sand.

| Minerals/Ions | % |
|---|---|
| SiO₂ | 0.3 |
| TiO₂ | — |
| Al₂O₃ | 0.23 |
| Fe₂O₃ | 0.07 |
| MgO | 0.98 |
| CaO | 53.39 |
| Na₂O | 0.34 |
| K₂O | 0.33 |
| MnO | — |
| Cl⁻ | 0.12 |
| P₂O₅ | 0.09 |
| SO₃_{^{−}} | 0.36 |
| CaCO₃ | 95.34 |
| Loss on ignition | 43.7 |

### Colloidal Silica

CS used in this study was synthesized by acidifying low-cost water glass (sodium silicate) with a 12M HCl solution and adjusting the pH at 7 in an acid-base neutralization reaction. Using sodium silicate as the raw material is reported in the literature to have several benefits such as low cost, slow growth rate, dense particles as well as the possibility for particle surface modification. The water glass was diluted with distilled water with a ratio of 2:1. Diluting the water glass with pure water is reported by to produce silica nanoparticles with a small volume mean diameter and a narrow particle size distribution. The aim of using a low-cost starting material was to produce large amounts of nano-sized silica and to allow for mass production to make the proposed treatment feasible on a field scale in ground improvement projects. The chemical reaction for CS synthesis is expressed in equation 15.

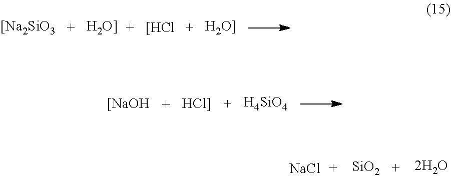

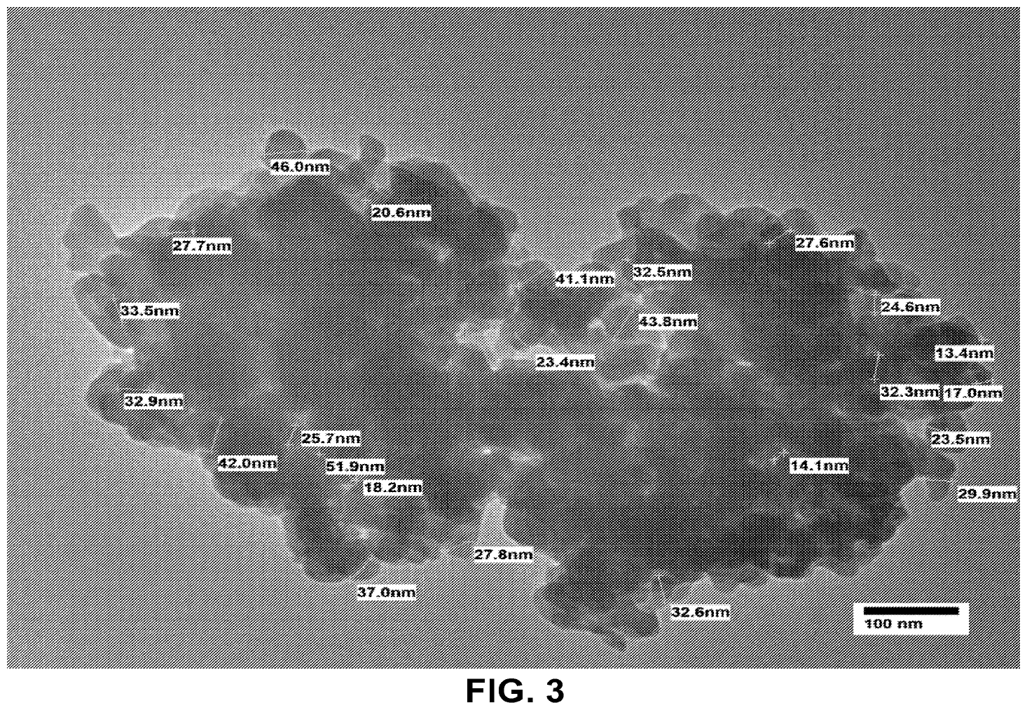

The suspension was oven dried at 100° C. to obtain a CS xerogel (dry gel). The xerogel was ball milled to remove any coagulation. The produced amorphous SiO₂ nanoparticles has specific surface area of 26 m²/gm, and particle size≈30 nm. EDX analysis excluded the presence of any impurities in the produced SiO₂. Index properties of CS used in the study are given in Table 2. Transmission electron microscopy (TEM) images of the CS nanoparticles are shown in FIG. 3.

TABLE 2
Index properties of CS.

| Index Property | Content | |
|---|---|---|
| Zeta potential | −44.1 | mV |
| Conductivity | 1.38 | mS/cm |
| Refractive index | 1.59 | |
| Average particle size | 30 | nm |
| pH range | 6-8 | |
| Viscosity | 0.8872 | cP |

### Alumina Powder

The alumina powder used in this study is ADVENT aluminum oxide neutral, 175 mesh (88 μm). The role of alumina is to act as an activator which promotes the pozzolanic reaction in addition to its filler effect. Through pozzolanic reactions with Ca(OH)₂, the Al₂O₃ particles form C—S—As within the mass of the treated sand. The alumina was added as 1% by weight of sand. The index properties of the alumina powder are given in Table 3.

TABLE 3
Index properties of alumina powder

| Property | Value |
|---|---|
| ASSAY | NLT 98% |
| pH aqueous solution 5% | 6-7.5 |
| Particle Size | Passes 175 mesh |
| Water soluble matter | 0.25% |
| Loss on ignition | 4% |

### Methodology

### Ek Cell

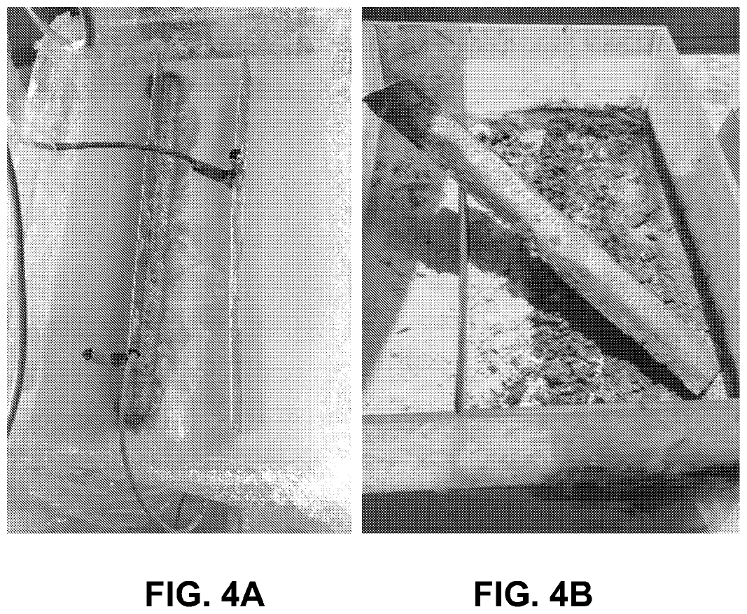

Treatments were conducted in eight identical electrolytic (EK) cells. Each cell is a 60 cm long, 40 cm wide, and 15 cm high acrylic tank with an open top to avoid pressure build up and to allow gases evolving at the anode and the cathode to escape. The acrylic used is 7 mm thick to resist potential distortion due to high temperatures generated by the electrokinetic process. FIGS. 4A-B show the Ek cell at the start of and after the EK treatment.

### Mixing

Twenty-five kilograms of virgin calcareous sand passing sieve #4 (4.75 mm) were used in the mix. CS nanoparticles and alumina powder were added to the sand as predetermined weights. CS nanoparticles and alumina powder were added as 1%, 5%, 10%, 15%, 20% and 25% and 1% by weight of sand, respectively.

For low initial conductivity soils, such as calcareous sand, addition of salt solutions is required for the transfer of the electric current between the soil particles. Brines were made from distilled water and NaCl powder. The CS-sand mix was mixed with 0.6M NaCl solution to serve as an aqueous electrolyte. The electrical conductivity of the NaCl solution is 5.5 S/m. The initial water content at the start of the EK treatment was 25%.

Uniform mixing of the stabilizing agents was ensured by mixing them with the sand inside a concrete drum type mixer. The pre-designed amount of salt solution was added gradually to the mixture in the drum mixer to ensure homogeneous mixing. The EK cell was then filled with the sand mix and placed on an electric shaker (vibrating table machine) to prevent the presence of air pockets in the sand. This is to avoid the formation of gaps or crevices within the mass of the rock formation resulting from the treatment, which would affect the results of the compressive and shear strengths testing. The double plate electrodes were then inserted into the sand-CS-alumina mix.

### Electrodes

In a pilot experiment, double perforated cylindrical stainless-steel electrodes were used as the anode and the cathode. Each cylinder had an inner diameter of 2.5 cm and was 25 cm long. The perforation holes were 2.5 mm in diameter. Electrode to electrode spacing was 20 cm centre to centre. The effect of EK treatment was found to be confined to the perimeters of the electrodes. Another alternative was to use multiple cylindrical electrodes to spread the mineral formation throughout the entire area of the EK cell. However, fewer samples would be extracted from the EK cell after the removal of the electrodes in such case, in addition to a more complex distribution of mineral formation due to overlapping between anodic and cathodic regions. Therefore, it was decided to use double stainless-steel electrodes instead of cylindrical electrodes. The aim was to induce cementation in a more uniform manner within the treated sand sample and to extend the zone of treatment along the whole area of the EK cell. Double iron plate electrodes were also used to compare the results with those obtained from using stainless-steel electrodes.

The plate electrodes were 50 cm long, 25 cm wide, with a thickness of 1.5 mm. Electrode to electrode spacing was 13.3 cm.

The double plate electrodes were connected to the power supply unit via crocodile clip cables.

### Power Supply, Current and Applied Voltage

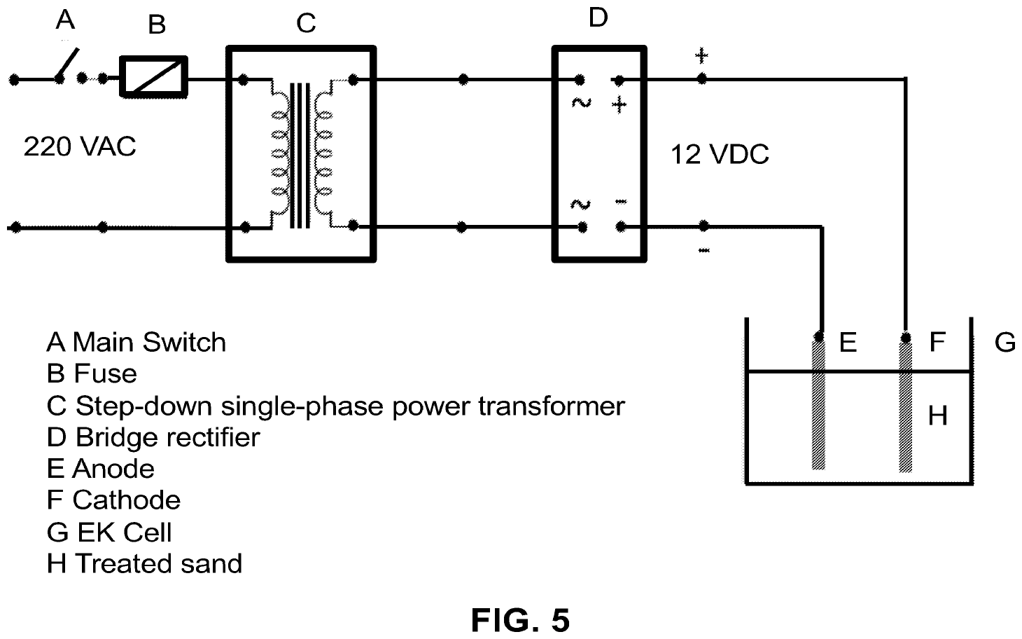

A step-down single-phase 220 V power transformer, designed and manufactured for the study, with multi outputs (12, 24, 36 and 48 V) with a total power of 2 KVA and a maximum rating of 41.6 A was used as a power supply. A bridge full wave rectifier with a maximum rating of 50 A was used to convert AC to DC. Capacitors were used for the smoothing of the DC signal obtained from the full wave rectifier to get a pure DC current. FIG. 5 depicts a block diagram for the test setup and the connection between the electric components and the electrodes in the EK cell.

The current intensity was monitored using a current meter connected to the power transformer-bridge rectifier system. The current intensity was initially high at the beginning of the treatment.

Gradual and slight increase in the current took place at the start of the process due to the high concentration of ions and their electromigration in the electrolyte solution. The current then started to decline.

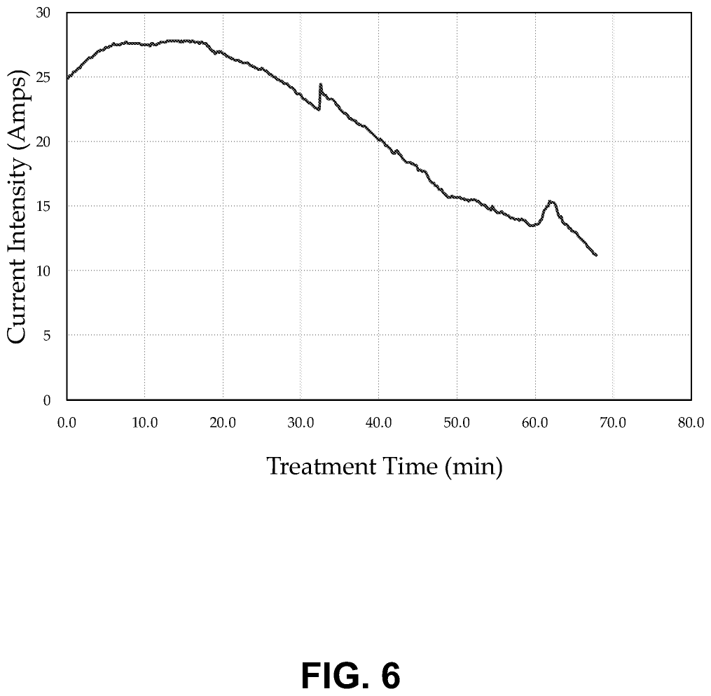

This decline happens upon reaching ionic equilibrium due to reduction in the concentration of mobile ions when the ions have reacted to form new compounds in the electrolyte solution. The water content decreased gradually due to evaporation arising from the heat generated by the EK treatment and due to water electrolysis. The decrease in water content over time caused the current intensity to decrease at constant voltage. At the same time, the soil resistivity arising from electrochemical changes within the soil mass caused the current to gradually decrease. The change of soil resistivity over time is due to electrochemical changes such as ion polarization in the soil pore fluid. The increases in soil resistivity with time is referred to as resistance polarization. As the soil resistivity increases with time, the current decreases under constant voltage. This means the current intensity becomes function in time under constant voltage. FIG. 6 shows the variation in current intensity with time at a constant voltage of 24 V. According to the available literature, similarly, if a constant current is applied, the corresponding applied voltage will increase. A study assessed the difference between constant voltage and constant current and found that there was no distinction between the two methods with respect to the properties of the treated soil. In the presented work, the multi outputs of the power transformer were used to keep the current constant by increasing the applied voltage when the current approached zero.

Current intermittence, regular or irregular, has been reported to reduce the rate of anode corrosion and power consumption. In the presented study, current intermittence was not applied; however, the current was turned off at weekends. This means the electricity was applied for five days, turned off for 65 hours and then reconnected for another two days.

### Incorporation of EKGs

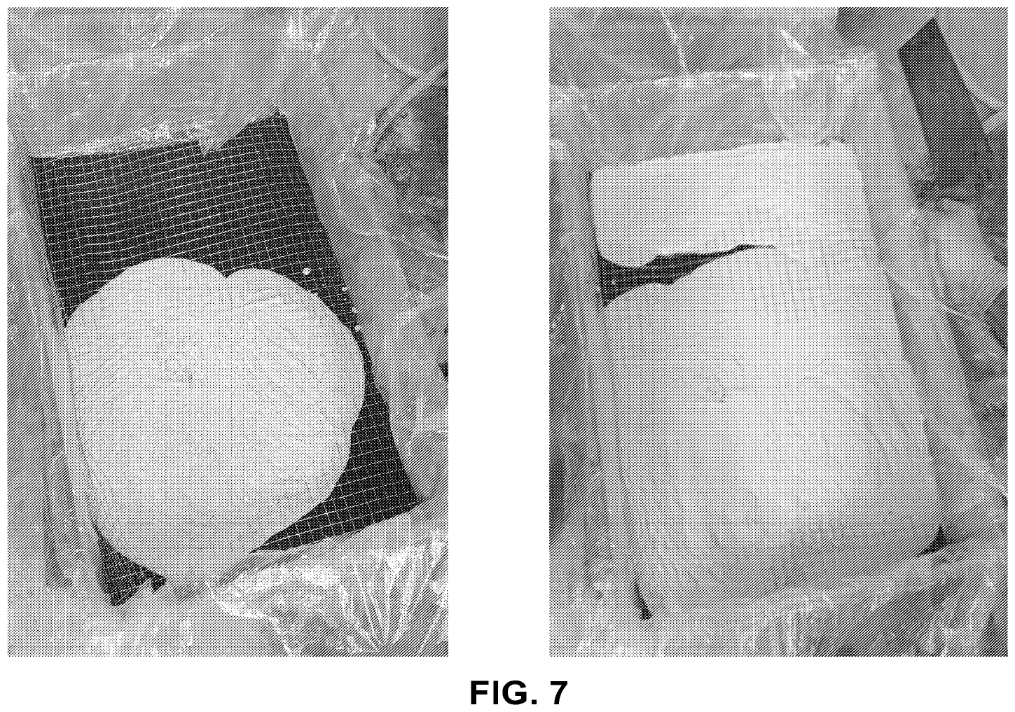

The electrokinetic geosynthetic used in the innovation is a composite material consisting of a 0.9 mm thick geomembrane sheet obtained from Solmax company and a 10×10 mm iron mesh. The EKG was placed horizontally at the bottom of the EK cell as shown in FIG. 7. The EKG served as the cathode and a 500×120×1 mm iron plate electrode was used as the anode. The anode was placed perpendicular to the EKG at one side of the EK cell. Precautions were taken to avoid a short circuit by isolating the EKG (cathode) from the anode using Styrofoam.

### Results

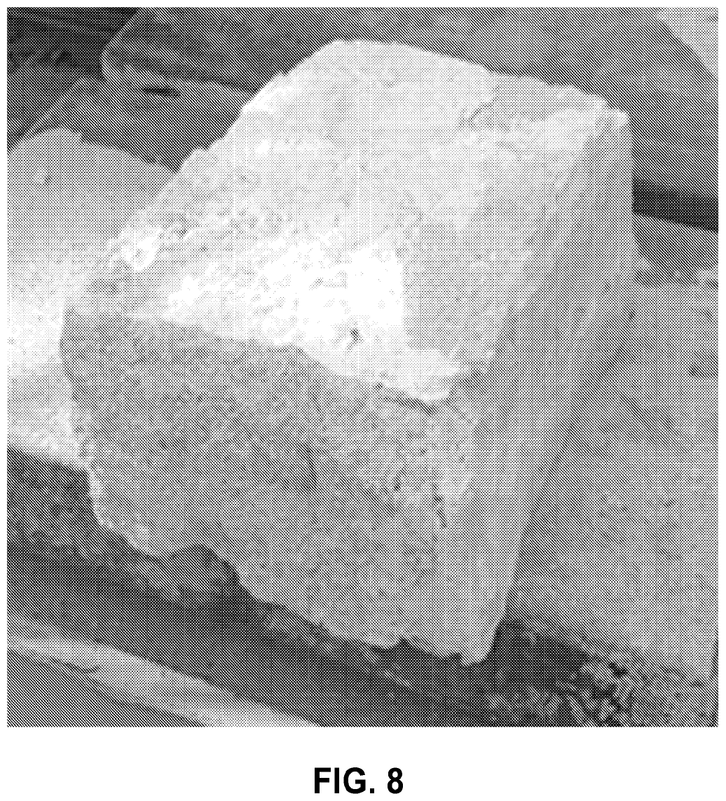

Results show that the application of a DC current along the calcareous sand sample in the presence of the CS and alumina powder brings about significant improvement in the compressive and shear strengths of the treated sand. The treatment can be considered an artificial lithification process through which the nature of the treated soil is changed from a granular material into a rock formation, whose chemical structure is similar to that of artificial siliceous limestone, as shown in FIG. 8.

The application of the EK treatment without adding any chemical stabilizers brings about minor improvement in the compressive and shear strengths of the treated sand samples.

The addition of CS nanoparticles alone without alumina powder significantly improves the compressive and shear strengths of the treated sand samples. The improvement is directly proportional to the percent weight of CS nanoparticles. The optimum percent weight of CS is 20%. Upon the addition of 25% CS, the improvements in compressive and shear strengths start to decline. However, the binary effect of using both CS and alumina powder yields the highest compressive and shear strengths.

The results obtained from using double iron plate electrodes are like those obtained from using stainless-steel plate electrodes.

The mechanical properties of the treated sand obtained from using the EKG as a cathode were higher than those obtained with double plate electrodes.

### Spectroscopic Analyses for Treated Sand

Spectroscopic analyses were carried out using field emission scanning electron microscopic imaging (FE-SEM), energy dispersive x-ray (EDX) and (EDX) mapping and x-ray diffraction (XRD) tests to compare samples of the calcareous sand before and after the EK treatments with respect to the change in soil fabric and the cementation brought about by electromigration, ion precipitation and pozzolanic activity. Results obtained from mineralogical and microstructural tests were used to explain the strength development which relates to the microstructure of the soil and the achieved cementation.

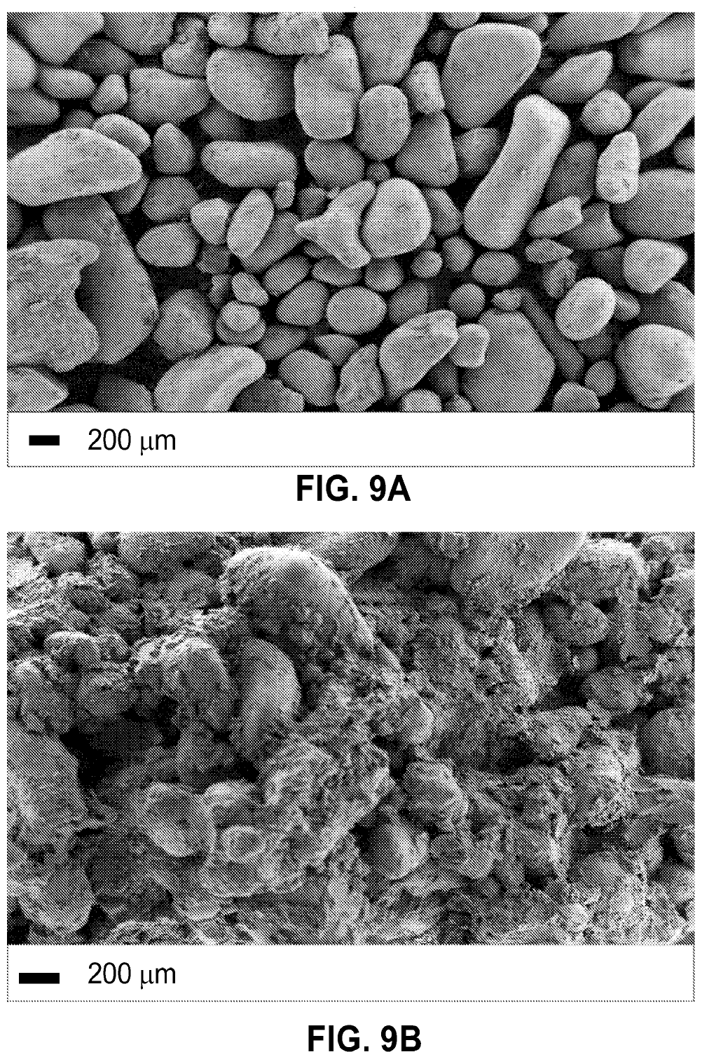

Morphology of the crystals of the cementitious materials formed within the treated sand was observed by high-resolution field emission scanning electron microscope (FE SEM), which enabled the detection and the identification of the crystallographic structure of the newly formed minerals. The images confirmed the cementation of the treated sand and the formation of C—S—Hs and C-A-Hs as well as iron-rich cements, which are not found in the original sand. FIGS. 9A-B show the SEM images of calcareous sand before and after the treatment. The virgin calcareous sand grains contained minute holes on their surface. After treatment, cementitious materials filled these holes and the interparticle voids and joined the particles together in an intact way, as shown in FIG. 9B.

EDX analysis of untreated sand showed peaks of Ca, O and C, but no significant Si or Al were observed. Whereas EDX analyses of treated samples showed peaks of Si, Al, Fe, Cr, Ni, Mg, Na and Cl, in addition to the elements originally present in the virgin sand. EDX mapping showed considerable heterogeneity in the samples with respect to the concentration of elements within the same sample but at different points. This heterogeneity is the result of fluctuations in ionic concentrations during EK treatments.

XRD analysis confirmed the formation of goethite [α-FeO(OH)] which indicates the oxidation state change of Fe²⁺ (ferrous) to Fe³⁺ (ferric). Iron oxides resulting from the degradation of the anode formed the ferrite phase, which reacted with silicates and aluminates. Iron-rich cements were formed within the microstructure of the treated sand and were detected by FE SEM.

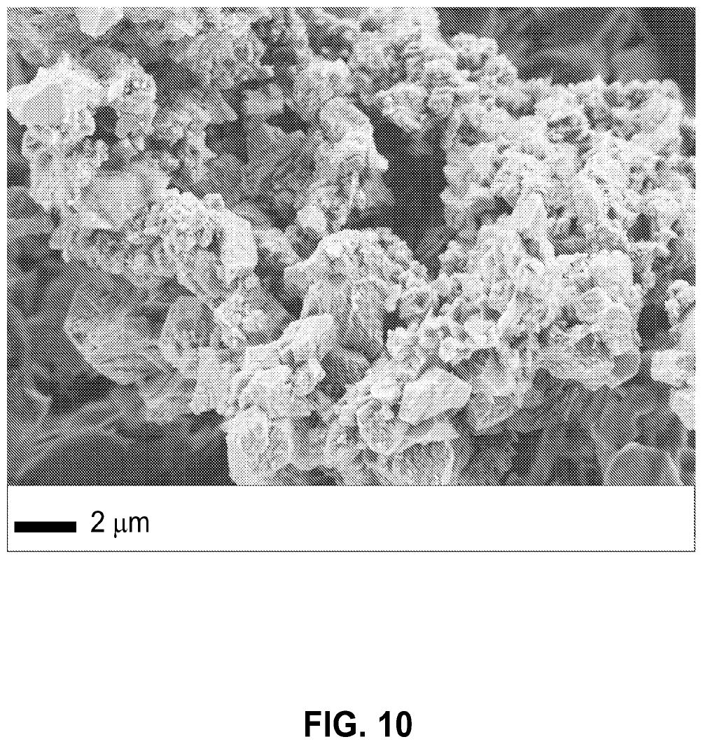

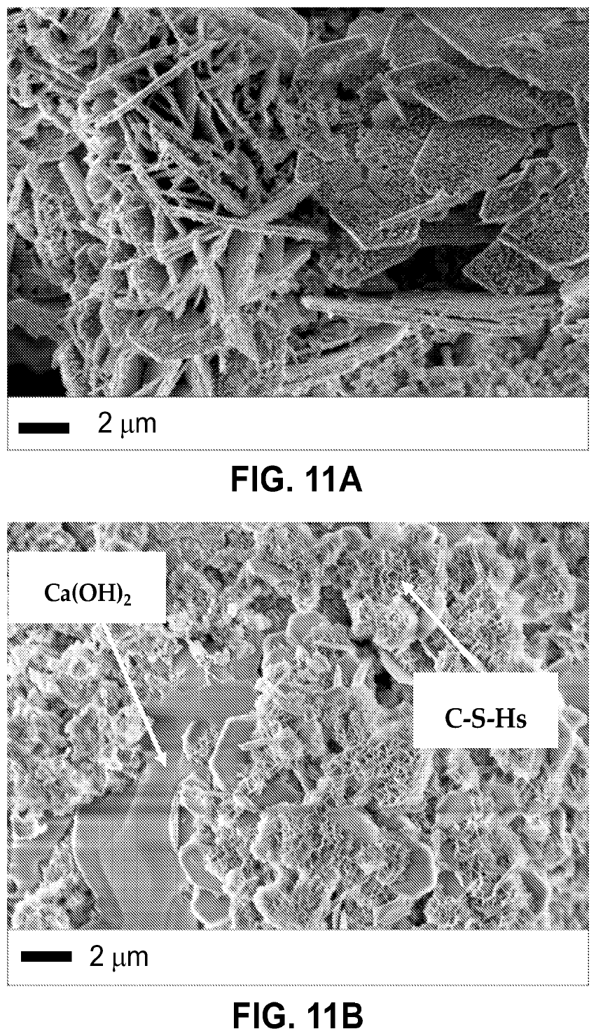

SEM image of iron-rich cements formed in treated samples, in which only the electric current was passed through the calcareous sand without adding any chemical stabilizers, is shown in FIG. 10.

In addition to the iron oxides precipitated in the soil due to the corrosion of stainless-steel electrodes, other elements present in the alloy including chromium, nickel and magnesium were detected by EDX analysis of the treated sand samples. Sulfur is also naturally present in stainless-steel and sometimes added to enhance the properties of the alloy. It is usually bonded in the form of manganese sulphides. The presence of this non-metallic element was also confirmed by EDX and EDX mapping of the treated sand. The above-mentioned alloying elements resulted in the formation of additional minerals in the treated calcareous sand including calcium magnesium carbonate [(Ca,Mg)(CO₃)] and gypsum (CaSO₄·2H₂O) as revealed by XRD analysis of the treated samples.

Crystalline plates of Portlandite [Ca(OH)₂] and C—S—Hs detected in treated sand samples are shown in the SEM image in FIGS. 11A-B. SiO₂ nanoparticles reacted with Ca(OH)₂ and formed C—S—Hs in the form of tobermorite gel (C₃S₂H₃), dicalcium silicate (C₂S), and tricalcium silicate (C₃S), which are the main strength-contributing components of the pozzolanic activity. The pozzolanic reactions created various compounds and gels and caused alterations in the microstructure of the treated sand and resulted in its hardness. The microstructures of the treated sand samples were assessed for long-term reactions. Calcium hydroxide and silicon oxide were the feedstocks for pozzolanic reactions. Consequently, the increase in CS percent weight in the mix caused the pores between sand particles to be filled with more cementitious compounds and hence, resulted in more pronounced flocculation structures. Thus, the compressive and shear strengths increased as the percentage weight of CS increased.

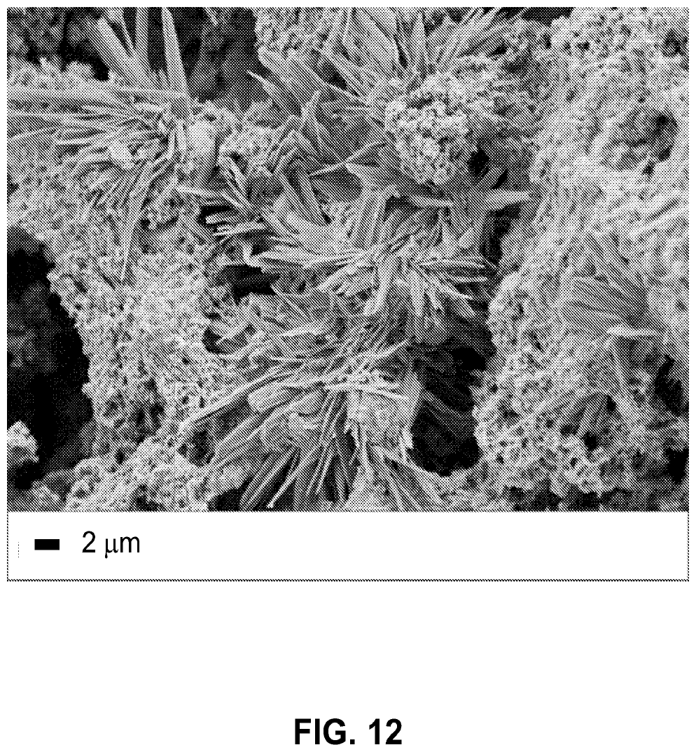

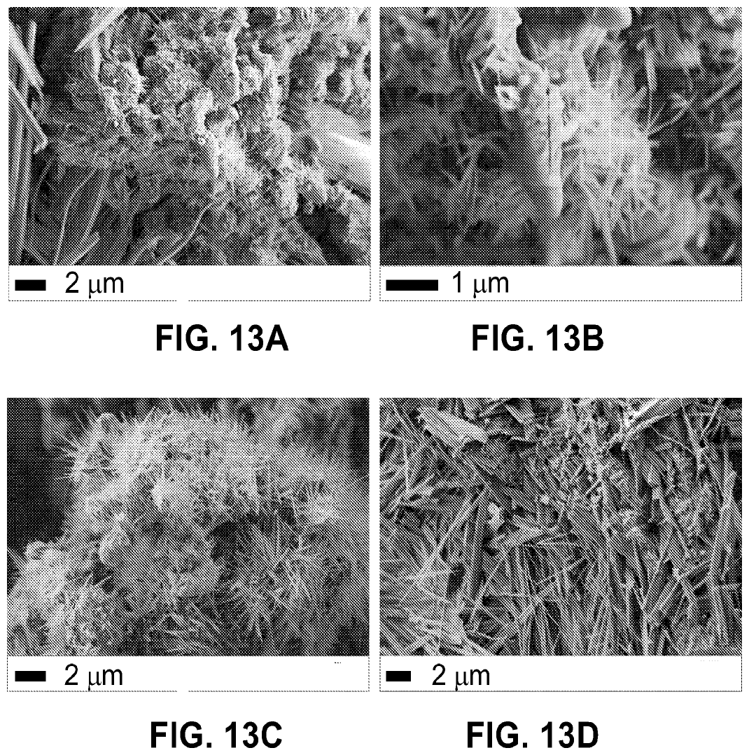

Self-oriented rosettes of C—S—Hs grown in treated sand samples are shown in FIG. 12. In addition, FIGS. 13A-D show SEM images displaying various microstructures of C—S—Hs formed within treated samples including nodules, needle form and rods of C—S—Hs.

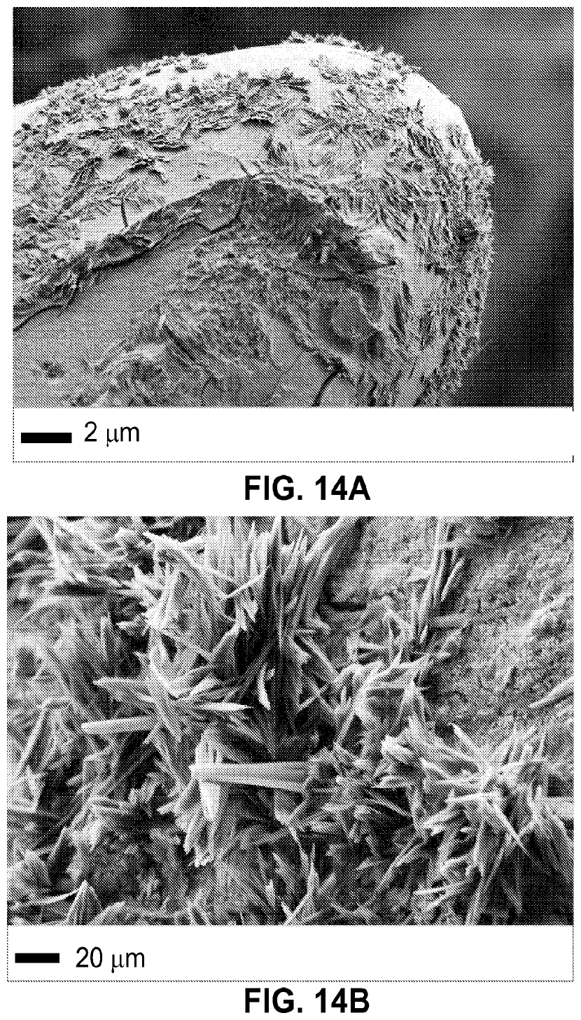

The presence of alumina powder (Al₂O₃) further contributed to the strength gain through the formation of aluminates with the end-product, ettringite (3CaO·Al₂O₃·3CaSO₄). FIGS. 14 to 23 show the microstructural developments in the matrix of the electro-chemically stabilized calcareous sand as a result of the synergistic effect of the two pozzolans. The samples contained 20% CS nanoparticles and 1% alumina powder by weight of sand. The SEM images showed diverse polymorphisms and the growth of C—S—Hs and C-A-Hs on the surface of individual sand grains, as well as between grains, as displayed in FIGS. 14A-B, respectively.

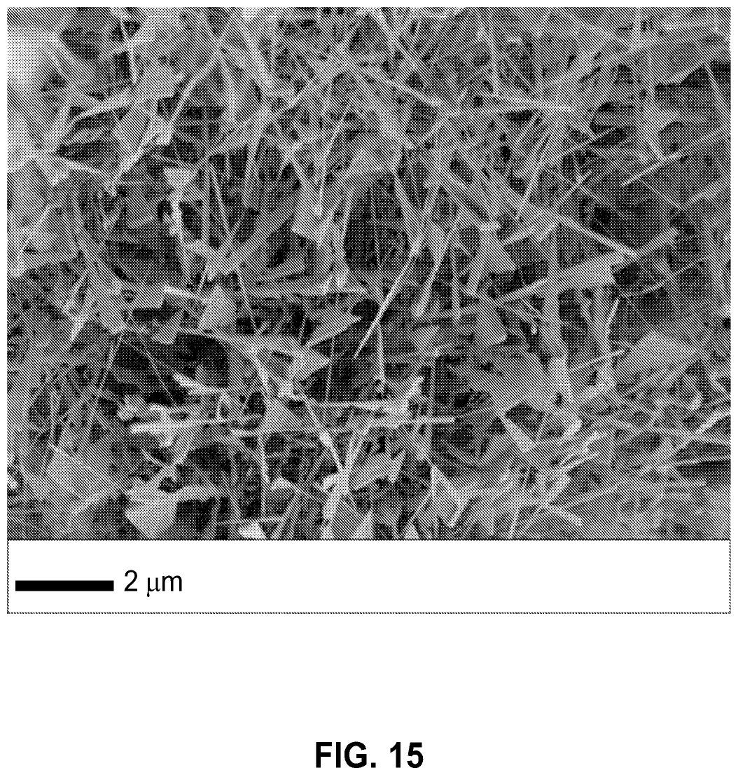

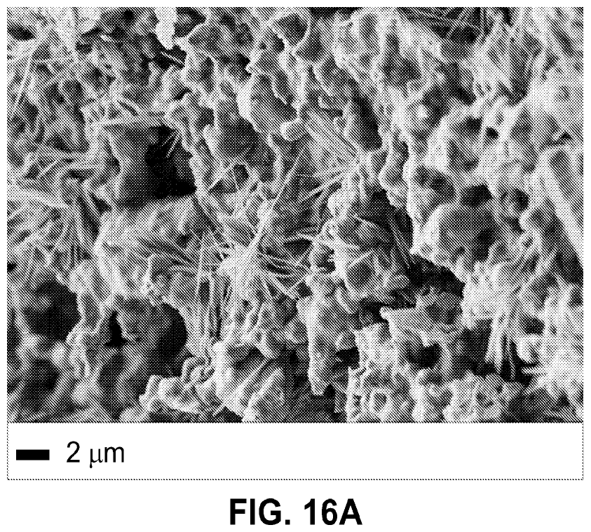

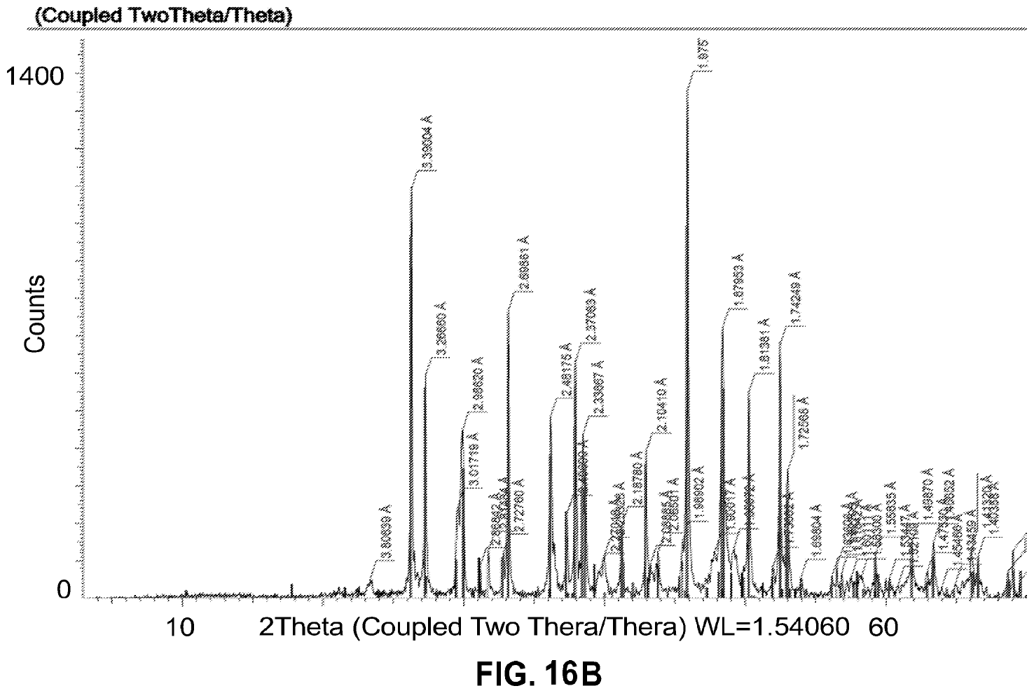

Crystalline calcium silicate hydrate (C—S—H) phases arise in the microstructure of the treated sand samples. Amorphous tobermorite gel (3CaO 2SiO₂·3H₂O) is shown in FIG. 15. Alpha-dicalcium silicate hydrate, hillebrandite, α-C₂SH (Ca₂[HSiO₄](OH)) is detected in SEM images and confirmed by XRD analysis, as shown in FIGS. 16A-B, respectively. The mineral Yoshiokaite, ((Ca,Na)[Al(Al,Si)O4]), was also detected by XRD analysis, as shown in FIG. 16B.

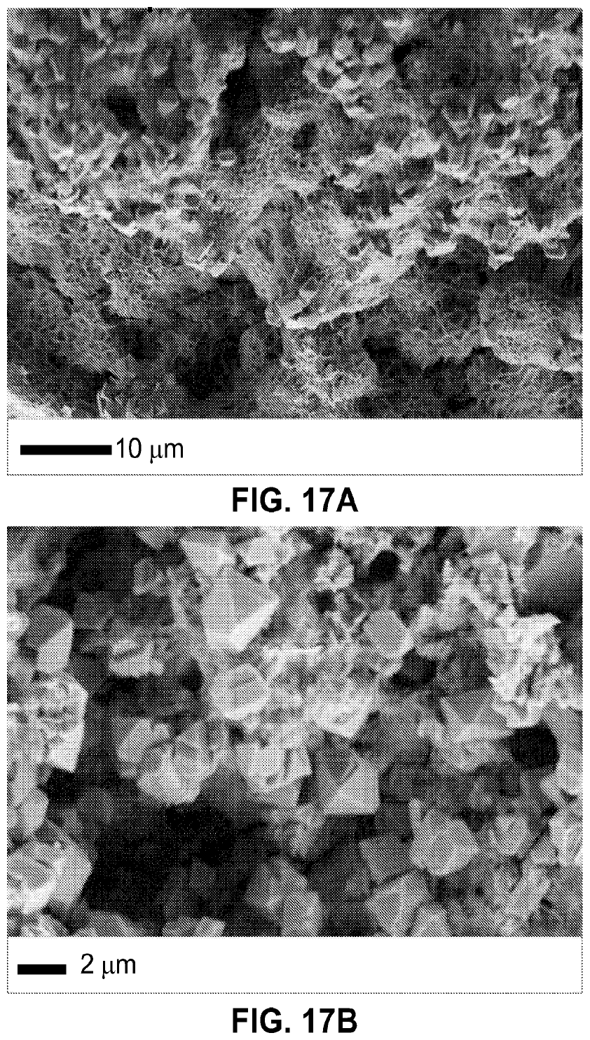

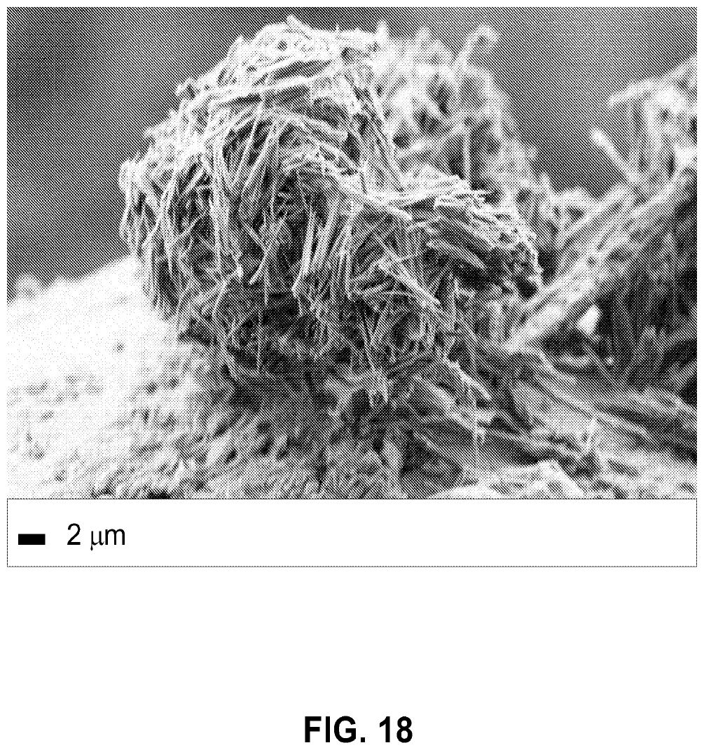

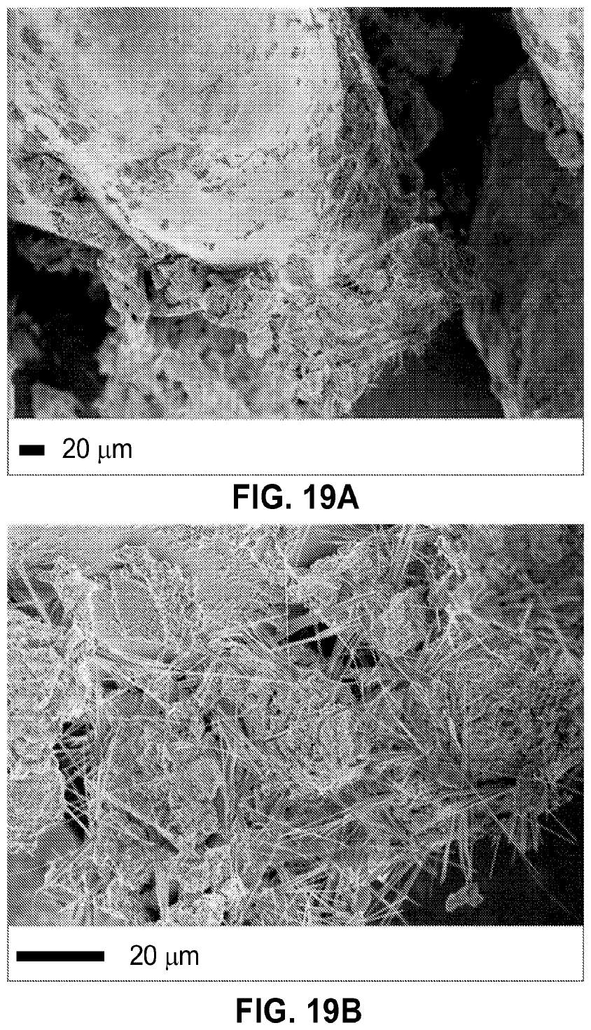

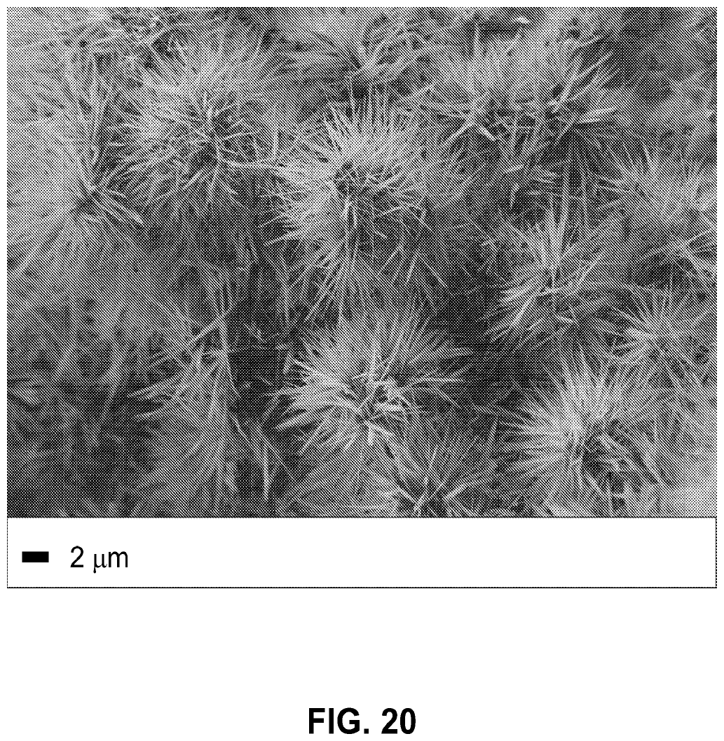

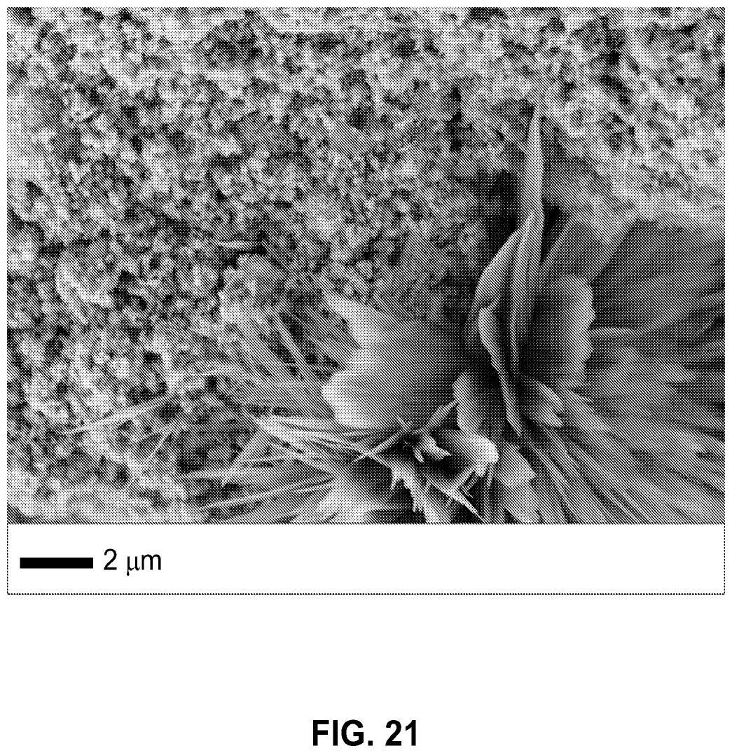

Octahedral hydrogarnet, Ca₃Al₂(OH)₁₂—Ca₃Al₂Si(OH)₈, was detected along with honeycomb structures of C—S—Hs as displayed in FIGS. 17A-B. SEM image of calcium aluminate, possibly pleochroite, is shown in FIG. 18. Rigid needle-like crystals of hydrous calcium aluminium sulfate (AFT), known as ettringite [3CaO·Al₂O₃·3CaSO₄·32H₂O], were detected in the treated samples, as shown in FIGS. 19A-B. FIG. 20 shows a SEM image of floral formations of C-A-Hs formed within treated samples. FIG. 21 shows a SEM image of a rosette of layered C-A-H grown between C—S—Hs.

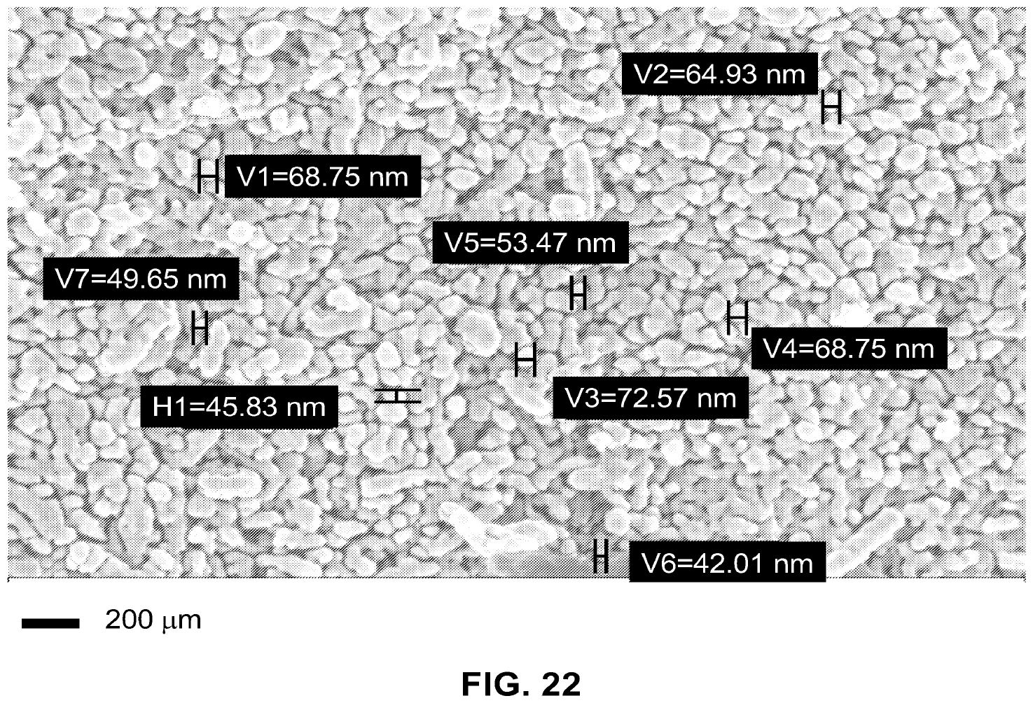

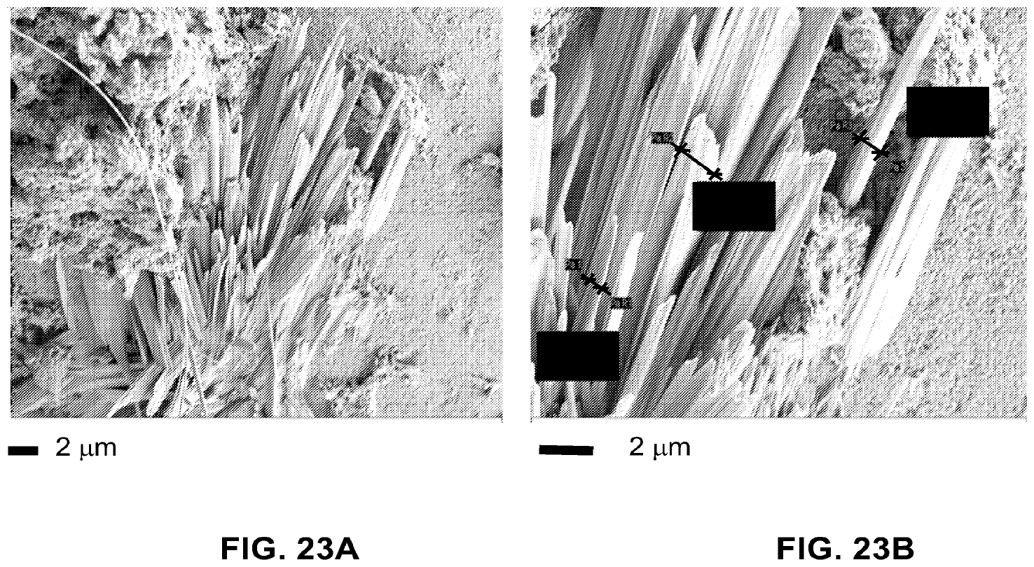

FIG. 22 shows nano features confirmed by FE-SEM imaging. SEM images of nano-sized aluminate hydrates formed on the surface of individual calcareous sand particles at magnifications of 2.6K and 6K are shown in FIGS. 23A-B, respectively.

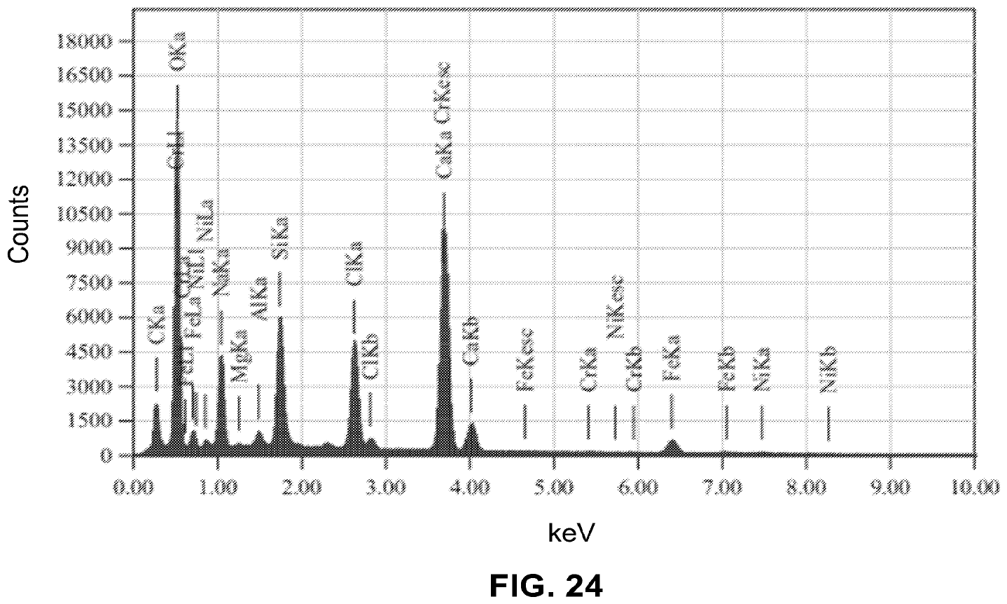

Energy dispersive x-ray (EDX) analysis for treated sand samples containing 20% CS and 1% alumina powder is shown in FIG. 24.

What is claimed is:

1. A method of stabilization or electro-cementation of calcareous sand, comprising:
(a) mixing calcareous sand, SiO₂ nanoparticles, Al₂O₃ powder and NaCl solution; and
(b) treating the mixture by passing a DC current through the mixture at a DC current intensity sufficient to ensure pozzolanic reactions to place within the mixture.

2. The method as set forth in claim 1, wherein the applied voltage is in the range of 12 V to 36 V.

3. The method as set forth in claim 1, wherein SiO₂ has a percent weight ratio within the mixture relative to the calcareous sand in a range of 10% to 20%.

4. The method as set forth in claim 1, wherein Al₂O₃ has a percent weight ratio within the mixture relative to the calcareous sand in a range of 1% to 10%.

5. The method as set forth in claim 1, wherein the concentration of NaCl solution is equal to the concentration of salt in seawater which is about 35 parts per thousand (3.5%) or about 0.6M.

6. The method as set forth in claim 1, wherein the treating lasts at least 60 days.

7. The method as set forth in claim 1, further comprising testing or loading the treated mixture.

8. The method as set forth in claim 1, wherein the passing of the DC current is accomplished by using double stainless-steel/iron plate electrodes or one stainless-steel/iron plate electrode as the anode along with an electrokinetic geosynthetic (EKG) comprising an iron mesh and a geomembrane as the cathode.
